(19) United States
(12) Patent Application Publication
(10) Pub. No.: US 2021/0332882 A1
(43) Pub. Date: Oct. 28, 2021

(54) Gear-Shifting Device for a Transmission

(71) Applicant: KNORR-BREMSE Systeme fuer Nutzfahrzeuge GmbH, Muenchen (DE)

(72) Inventors: Sebastian SCHALLER, Langweid (DE); Martin KRAL, Muenchen (DE); Juergen SCHUDY, Muenchen (DE)

(21) Appl. No.: 17/264,576

(22) PCT Filed: Jul. 10, 2019
(86) PCT No.: PCT/EP2019/068602

§ 371 Date: Jan. 29, 2021

(30) Foreign Application Priority Data
Jul. 30, 2018 (DE) 10 2018 212 694.1

(51) Int. Cl. F16H 61/32; F16H 61/30; F16H 63/32; F16H 63/08

(52) U.S. Cl. CPC F16H 61/32; F16H 61/30; F16H 2061/2869; F16H 63/08; F16H 63/32

(57) ABSTRACT

A gear-shifting mechanism for a transmission has a gear-shifting actuating unit with a gear-shifting actuator that can be moved along a gear-shifting actuating axis, and a selection unit that can be connected to the gear-shifting actuator. The selection unit has a selection element which is designed to adopt different positions in a direction that is non-parallel to the gear-shifting actuating axis, in order to be able to connect to different selector forks in the different positions, for moving transmission components for shifting gears, and a switching actuator having a switching actuator axis that defines a switching movement of the switching actuator for moving the selection element into the different positions. The switching actuator axis and the gear-shifting actuating axis are oriented such that they are parallel to each other.

### BACKGROUND AND SUMMARY OF THE INVENTION

The invention relates to a gear-shifting mechanism for a transmission, in particular a gear-shifting mechanism for a manual transmission of a vehicle.

Gear-shifting mechanisms for transmissions which carry out a shift gate selection in a manual transmission in order by way of specific shift forks to displace transmission components, for example gear wheels or drivers, for shifting of gears are known. The shift gates are usually disposed beside one another in a direction parallel to the transmission shafts of the transmission and are mutually parallel. By virtue of the modern construction of vehicles, in particular commercial vehicles, it is no longer expedient for the shift gate to be selected by moving back and forth a shift lever as before. For this reason, shift gate selection actuators are used for selecting the desired shift gate.

Since the shift gates are disposed so as to be mutually parallel in the direction of the transmission shafts, as mentioned above, the shift gate selection actuator is disposed so as to be perpendicular to the direction of the transmission shafts. This however takes up a large installation space, which is becoming ever more scarce in particular when taking into account an increasing number of construction modules and components.

The invention is thus based on the object of providing a gear-shifting mechanism and a method for shifting a transmission which eliminate the above disadvantage, wherein the gear-shifting mechanism is disposed independently of a shift lever and has a compact construction mode.

The object is achieved by a gear-shifting mechanism and by a method according to the independent claims. Advantageous refinements of the invention are the subject matter of the dependent claims.

According to one aspect of the invention, a gear-shifting mechanism for a transmission has a shift activation unit which in turn has a shift activation actuator which is movable along a shift activation axis. The gear-shifting mechanism furthermore has a selector unit which is able to be connected to the shift activation actuator. The selector unit contains a selector element which, in a direction that is not parallel to the shift activation axis, is configured for assuming different positions so as to be able to be connected in the different positions to different shift forks for displacing transmission components for shifting of gears. The selector unit furthermore contains a switchover actuator having a switchover actuator axis which defines a switchover movement of the switchover actuator to move the selector element into the different positions. The switchover actuator axis and the shift activation axis are aligned so as to be mutually parallel.

On account of this parallel disposal of the switchover actuator axis and the shift activation axis, said axes optionally also able to lie beside one another, the gear-shifting mechanism has a compact construction mode and can nevertheless be disposed independently of a shift lever.

In one advantageous refinement, the selector element is configured in the different positions to couple a shift rod of the transmission to the different shift forks in an axially displaceable manner.

By coupling the shift rod to the different shift forks, it is possible to use a reduced number of shift rods or only one shift rod in order for the plurality of shift forks to be selectively displaced. A required installation space is further reduced on account thereof.

In one further advantageous refinement, the gear-shifting mechanism has a rotary drive which is able to be connected to the selector element in order to rotate the selector element into the different positions. The rotary drive has a switchover actuator which is configured for generating a linear movement along the switchover actuator axis, as well has a converter unit which is able to be connected to the switchover actuator and is configured for converting the linear movement of the switchover actuator to a rotary movement of the rotary element about a rotation axis of the converter unit.

On account of this arrangement, the linear movement of the switchover actuator that is actuatable in a simple and precise manner can be converted to the different positions of the selector element.

In one advantageous further development, the converter unit has a gate guide which is configured to run about the rotation axis in the manner of a thread turn and is able to be connected to the switchover actuator. The gate guide encloses a predetermined pitch angle in relation to the rotation axis of the converter unit and, in terms of the converter unit, is disposed so as not to be rotatable about the rotation axis. The converter unit furthermore has an engagement portion which is configured for engaging into the gate guide, wherein the converter unit has a bearing point which is configured for mounting the engagement portion so as to be rotatable about the rotation axis. The engagement portion is able to be connected to the selector element such that a linear movement of the gate guide is able to be converted to a rotary movement of the selector element.

A precise allocation of the rotary movement to the linear movement is possible by providing the gate guide in conjunction with the engagement portion, so that a precise selection of a shift gate is readily possible.

In one further advantageous design embodiment, the pitch angle is configured such that said pitch angle corresponds to a steep-pitch thread, so that the gate guide and the engagement portion have a connection which is configured as not self-locking, and therefore the engagement portion is able to be rotated by a linear movement of the gate guide.

A correspondingly suitable fixing of the steep-pitch angle allows effortless activation, so that the switchover actuator can be designed with lower output and therefore, by virtue of the smaller installation size of the switchover actuator, installation space can in turn be saved.

In one advantageous refinement, the converter unit has a shift roller, and the gate guide is provided on the circumference of the shift roller.

The gate guide can be provided in a simple and cost-effective manner by providing the shift roller.

In one advantageous further development, the switchover actuator is configured for generating a rotary movement about the switchover actuator axis, and a transformation unit which is configured for transforming the rotary movement of the switchover actuator to a movement of the selector element in a direction not parallel to the shift activation axis is provided.

For example, a rotary movement of the switchover actuator can be transformed in a direction not parallel to the shift activation axis by way of a rack-and-pinion gear which converts a rotary movement of a gear wheel on the switchover actuator to a linear movement of the selector element that is connected to a rack, or the selector element can be connected directly to an operative element of the switchover actuator such that the rotary movement of the switchover actuator is transformed to a rotary movement of the selector element in a direction not parallel to the shift activation axis. On account thereof, the movement in a direction not parallel to the shift activation axis can be implemented in a simple manner.

When the gear-shifting mechanism alternatively has a hydraulically activatable switchover actuator, a pneumatically activatable switchover actuator or an electrically activatable switchover actuator, the gear-shifting mechanism can in each case be actuated in a simple and/or cost-effective manner, and the actuator drive mode can be suitably selected depending on the application.

According to a further aspect of the invention, a method for shifting a gear in a transmission having a gear-shifting mechanism comprises the following steps: activating the switchover actuator having the switchover actuator axis which is disposed so as to be parallel to the shift activation axis, so as to vary a position of the selector element in a direction not parallel to the switchover actuator axis such that the selector element in a specific shift gate is able to be connected to a specific shift fork; and activating the shift activation unit in order to establish a gear-specific connection within the transmission by way of the specific shift fork.

Shifting of gears is made possible by this method, wherein the gear-shifting mechanism has a compact construction mode and can nevertheless be disposed independently of a shift lever.

According to another further aspect of the invention, a method for shifting a gear in a transmission having a gear-shifting mechanism comprises the following steps: activating the switchover actuator having the switchover actuator axis which is disposed so as to be parallel to the shift activation axis, so as to vary a position of the selector element in a direction not parallel to the switchover actuator axis so that a shift rod is rotated such that said shift rod is coupled in an axially displaceable manner to a specific shift fork; and activating the shift activation unit in order to establish a gear-specific connection within the transmission by way of the specific shift fork.

By coupling the shift rod to the different shift forks, it is possible for a reduced number of shift rods or only one shift rod to be used for selectively displacing the plurality of shift forks. A required installation space is further reduced on account thereof.

In one advantageous further development, the varying of the position of the selector element takes place by actuating a switchover actuator, that generates a linear movement, by way of a converter unit for generating a rotary movement of the rotary drive in order to rotate the selector element into the different positions.

The linear movement of the switchover actuator can be converted in a simple and precise manner to the different positions of the selector element by this method, since the converter unit is of simple construction and can accordingly be adapted to the requirements in terms of precision.

In a further advantageous design embodiment, a linear movement of an actuator of the linear drive is converted to the rotary movement by way of a gate guide and an engagement element.

By providing the gate guide in conjunction with the engagement portion, a precise allocation of the rotary movement to the linear movement is possible here since a pitch angle of the gate guide can be selected according to the requirements, such that a precise selection of a shift gate is possible.

The invention will now be explained by means of an embodiment with reference to the appended drawings.

### BRIEF DESCRIPTION OF THE DRAWINGS

FIG. 1 shows an embodiment of a gear-shifting mechanism according to the invention.

FIG. 2 shows a flow chart of an exemplary method according to the invention.

### DETAILED DESCRIPTION OF THE DRAWINGS

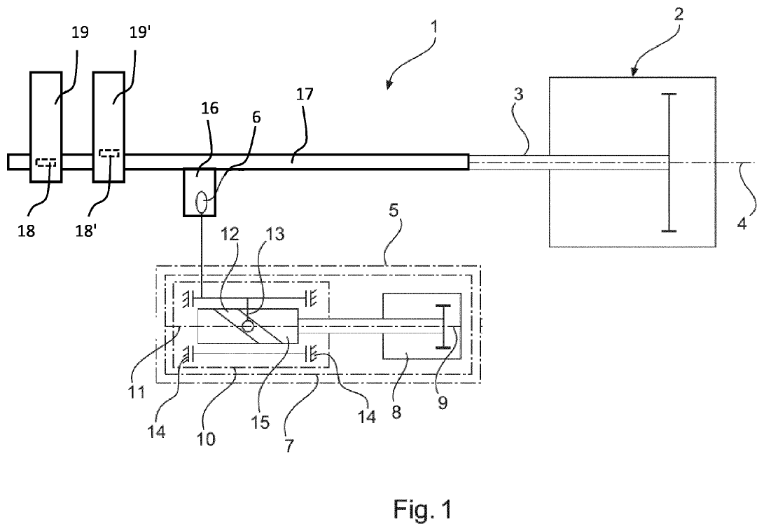

FIG. 1 shows an embodiment of a gear-shifting mechanism 1. The gear-shifting mechanism 1 has a shift activation unit 2 which in turn has a shift activation actuator 3 which is movable along a shift activation axis 4.

The gear-shifting mechanism 1 furthermore has a selector unit 5. The selector unit 5 has a selector element 6 which is configured for assuming different positions in a direction that is not parallel to the shift activation axis 4, thus for example in a direction that is orthogonal to the shift activation axis 4, thus perpendicular to the shift activation axis 4. In this case, the selector element 6 in the different positions is able to be connected to different shift forks 19, 19′ for displacing transmission components for shifting of gears. A shift rod 17 is rotated by the selector element 6 by way of a lever mechanism 16. Depending on the position of the selector element 6 and thus of a rotary angle of the shift rod 17, corresponding shift forks 19, 19′ are coupled or decoupled in an axially displaceable manner by way of cams 18, 18′ on the shift rod 17 and complementary clearances in the shift forks 19, 19′. Alternatively, the selector element 6 is able to be connected to the shift forks 19, 19′ in another way. For example, the selector element 6 engages in each case in a driver of shift rods in different shift gates, said shift rods being in each case connected to one shift fork 19, 19′.

The gear-shifting mechanism 1 moreover has a rotary drive 7 which is able to be connected to the selector element 6 in order to rotate the selector element 6 into the different positions.

The rotary drive 7 in turn has a switchover actuator 8 which is configured for generating a linear movement along a switchover actuator axis 9. The rotary drive 7 furthermore has a converter unit 10 which is connected to the switchover actuator 9. The converter unit 10 converts the linear movement of the switchover actuator 8 to a rotary movement of the selector element 6 about a rotation axis 11 of the converter unit 10.

The converter unit 10 is provided with a gate guide 12 which is configured to run about the rotation axis 11 in the manner of a thread turn. The gate guide 12 is connected to the switchover actuator 8, wherein the gate guide 12 has a predetermined pitch angle α in relation to the rotation axis 11 and in terms of the converter unit 10 is disposed so as not to be rotatable about the rotation axis 11 of the converter unit 10. The gate guide 12 is provided on the circumference of a shift roller 15. Alternatively, the gate guide 12 is not provided on the shift roller 15, but the gate guide 12 is contained by another geometric body.

The converter unit 10 is furthermore provided with an engagement portion 13 which is configured for engaging into the gate guide 12. The converter unit 10 moreover has a bearing point 14 which is configured for mounting the engagement portion 13 so as to be rotatable about the rotation axis 11. The engagement portion 13 is connected to a selector element 6 such that a linear movement of the gate guide 12 along the switchover actuator axis 9 is converted to a rotary movement of the selector element 6.

The above-mentioned pitch angle α is configured such that said pitch angle corresponds to a steep-pitch thread, so that the gate guide 12 and the engagement portion 13 have a connection which is configured as not self-locking, and therefore the engagement portion 13 is able to be rotated by the linear movement of the gate guide 12. Alternatively, the gate guide 12 and the engagement portion 13 are not provided, but a cam mechanism is alternatively provided in order to convert the linear movement of the switchover actuator 8 to the rotary movement of the selector element 6.

In an alternative embodiment, the gear-shifting mechanism 1 does not have any rotary drive 7 which rotates the selector element 6 into the different positions, but has a transformation unit which transforms a rotary movement of the switchover actuator 8 about the switchover actuator axis 9 to a movement of the selector element 6 in a direction not parallel to the shift activation axis 4. No transformation unit is provided in a further alternative embodiment either, but the selector element 6 is connected directly to the switchover actuator 8 which in this instance, in a direction not parallel to the shift activation axis 4, rotates the selector element 6 into the different positions. The switchover actuator axis 9 however defines the switchover movement in all cases, specifically either the linear movement along the switchover actuator axis 9 or the rotary movement about the switchover actuator axis 9. The switchover actuator axis 9 and the shift activation axis 4 are in all cases aligned so as to be mutually parallel.

The switchover actuator 8 is embodied as an electrically activatable switchover actuator 8. Alternatively, a hydraulically activatable switchover actuator 8 or pneumatically activatable switchover actuator may also be provided.

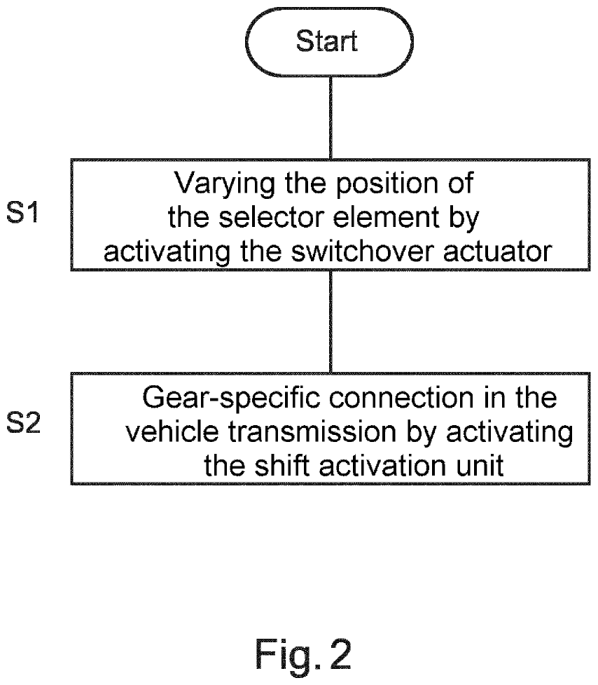

A flow chart of a method according to the invention is shown in FIG. 2. During operation, the switchover actuator 8 having the switchover actuator axis 9 which is aligned so as to be parallel to the shift actuation axis 4, is activated in step S1 to vary a position of the selector element 6 in a direction not parallel to the switchover actuator axis 9, such that the selector element 6 in a specific shift gate is connected to a shift fork 19, 19′. Subsequently, in step S2 the shift activation unit 2 is activated in order to establish a gear-specific connection within the transmission by way of the specific shift fork 19, 19′.

The varying of the position of the selector element 6 takes place by actuating the switchover actuator 8, which generates the linear movement, by way of a converter unit 10 for generating the rotary movement of a rotary drive 7 in order to rotate the selector element 6 into the different positions. The linear movement of the switchover actuator 8 is converted to the rotary movement by way of the gate guide 12 and the engagement element 13. Alternatively, the linear movement is converted to the rotary movement by way of a cam mechanism, for example. In further alternative embodiments, moving into the different positions takes place by way of a rotary movement by the switchover actuator 8, said rotary movement, optionally converted by way of a transformation unit, being converted to a movement for varying a position of the selector element 6 in a direction not parallel to the switchover actuator axis 9.

All features illustrated in the description, the following claims and the drawing can be essential to the invention individually as well as in any arbitrary combination.

### LIST OF REFERENCE SIGNS

1 Gear-shifting mechanism
2 Shift activation unit
3 Shift activation actuator
4 Shift activation axis
5 Selector unit
6 Selector element
7 Rotary drive
8 Switchover actuator
9 Switchover actuator axis
10 Converter unit
11 Rotation axis
12 Gate guide
13 Engagement portion
14 Bearing point
15 Shift roller
16 Lever mechanism
17 Shift rod
18, 18′ Cam
19, 19′ Shift fork

1.-14. (canceled)

15. A gear-shifting mechanism for a transmission, comprising:
a shift activation unit which has a shift activation actuator which is movable along a shift activation axis; and
a selector unit which is able to be connected to the shift activation actuator, wherein
the selector unit comprises:
a selector element which, in a direction that is not parallel to the shift activation axis, is configured for assuming different positions so as to be able to be connected in the different positions to different shift forks for displacing transmission components for shifting of gears; and
a switchover actuator having a switchover actuator axis which defines a switchover movement of the switchover actuator to move the selector element into the different positions, wherein
the switchover actuator axis and the shift activation axis are aligned so as to be mutually parallel.

16. The gear-shifting mechanism as claimed in claim 15, wherein
the selector element is configured in the different positions to couple a shift rod of the transmission to the different shift forks in an axially displaceable manner, by way of cams on the shift rod and complementary clearances in the shift forks.

17. The gear-shifting mechanism as claimed in claim 15, wherein
the gear-shifting mechanism has a rotary drive which is able to be connected to the selector element in order to rotate the selector element into the different positions, wherein
the rotary drive comprises:
the switchover actuator, which is configured for generating a linear movement along the switchover actuator axis, and
a converter unit which is able to be connected to the switchover actuator and is configured for converting the linear movement of the switchover actuator to a rotary movement of the selector element about a rotation axis of the converter unit.

18. The gear-shifting mechanism as claimed in claim 17, wherein the converter unit comprises:
a gate guide which is configured to run about the rotation axis of the converter unit in the manner of a thread turn and is able to be connected to the switchover actuator, wherein the gate guide has a predetermined pitch angle in relation to the rotation axis and, in terms of the converter unit, is disposed so as not to be rotatable about the rotation axis; and
an engagement portion which is able to be connected to the selector element, wherein the engagement portion is configured for engaging into the gate guide; and
a bearing point which is configured for mounting the engagement portion so as to be rotatable about the rotation axis; wherein
the engagement portion is able to be connected to the selector element such that a linear movement of the gate guide along the switchover actuator axis is able to be converted to a rotary movement of the selector element about the rotation axis.

19. The gear-shifting mechanism as claimed in claim 18, wherein
the pitch angle is configured such that said pitch angle corresponds to a steep-pitch thread such that the gate guide and the engagement portion have a connection which is configured as not self-locking, whereby the engagement portion is able to be rotated about the rotation axis by the linear movement of the gate guide.

20. The gear-shifting mechanism as claimed in claim 18, wherein
the converter unit has a shift roller, and
the gate guide is provided on a periphery of the shift roller.

21. The gear-shifting mechanism as claimed in claim 15, wherein
the switchover actuator is configured for generating a rotary movement about the switchover actuator axis, and further comprising:
a transformation unit which is configured for transforming the rotary movement of the switchover actuator to a movement of the selector element in a direction not parallel to the shift activation axis.

22. The gear-shifting mechanism as claimed in claim 15, wherein
the gear-shifting mechanism has a hydraulically activatable switchover actuator.

23. The gear-shifting mechanism as claimed in claim 15, wherein
the gear-shifting mechanism has a pneumatically activatable switchover actuator.

24. The gear-shifting mechanism as claimed in claim 15, wherein
the gear-shifting mechanism has an electrically activatable switchover actuator.

25. A method for shifting a gear in a transmission having a gear-shifting mechanism that comprises:
a shift activation unit which has a shift activation actuator which is movable along a shift activation axis; and
a selector unit which is able to be connected to the shift activation actuator, the selector unit including:
a selector element which, in a direction that is not parallel to the shift activation axis, is configured for assuming different positions so as to be able to be connected in the different positions to different shift forks for displacing transmission components for shifting of gears; and
a switchover actuator having a switchover actuator axis which defines a switchover movement of the switchover actuator to move the selector element into the different positions, wherein
the switchover actuator axis and the shift activation axis are aligned so as to be mutually parallel,
the method comprising the steps of:
activating the switchover actuator having the switchover actuator axis which is aligned so as to be parallel to the shift activation axis, so as to vary a position of the selector element in a direction not parallel to the switchover actuator axis such that the selector element in a specific shift gate is able to be connected to a specific shift fork; and
activating the shift activation unit in order to establish a gear-specific connection within the transmission by way of the specific shift fork.

26. The method as claimed in claim 25, wherein
the varying of the position of the selector element takes place by actuating the switchover actuator, which generates a linear movement, by way of a converter unit for generating a rotary movement of a rotary drive so as to rotate the selector element into the different positions.

27. The method as claimed in claim 26, wherein
a linear movement of the switchover actuator is converted to the rotary movement by way of a gate guide that is connected to the switchover actuator and an engagement element that is connected to the selector element.

28. A method for shifting a gear in a transmission having a gear-shifting mechanism that comprises:
a shift activation unit which has a shift activation actuator which is movable along a shift activation axis; and
a selector unit which is able to be connected to the shift activation actuator, the selector unit including:
a selector element which, in a direction that is not parallel to the shift activation axis, is configured for assuming different positions so as to be able to be connected in the different positions to different shift forks for displacing transmission components for shifting of gears; and
a switchover actuator having a switchover actuator axis which defines a switchover movement of the switchover actuator to move the selector element into the different positions,
wherein the switchover actuator axis and the shift activation axis are aligned so as to be mutually parallel, and
wherein the selector element is configured in the different positions to couple a shift rod of the transmission to the different shift forks in an axially displaceable manner, by way of cams on the shift rod and complementary clearances in the shift forks,
the method comprising the steps of:
activating the switchover actuator having the switchover actuator axis which is aligned so as to be parallel to the shift activation axis, so as to vary a position of the selector element in a direction not parallel to the switchover actuator axis such that the shift rod is rotated so that said shift rod is coupled in an axially displaceable manner to a specific shift fork; and
activating the shift activation unit in order to establish a gear-specific connection within the transmission by way of the specific shift fork.

29. The method as claimed in claim 28, wherein
the varying of the position of the selector element takes place by actuating the switchover actuator, which generates a linear movement, by way of a converter unit for generating a rotary movement of a rotary drive so as to rotate the selector element into the different positions.

30. The method as claimed in claim 29, wherein
a linear movement of the switchover actuator is converted to the rotary movement by way of a gate guide that is connected to the switchover actuator and an engagement element that is connected to the selector element.
